(19) United States
(12) Patent Application Publication
(10) Pub. No.: US 2026/0303818 A1
(43) Pub. Date: Oct. 1, 2026

(54) ADAPTIVE MOTION VECTOR PREDICTOR WITH DECODER SIDE MOTION VECTOR REFINEMENT

(71) Applicant: Alibaba (China) Co., Ltd., Hangzhou (CN)

(72) Inventors: Ru-ling LIAO, Sunnyvale, CA (US); Jie CHEN, Beijing (CN); Xinwei LI, Beijing (CN); Yan YE, San Diego, CA (US)

(21) Appl. No.: 19/559,744

(22) Filed: Mar. 6, 2026

Related U.S. Application Data
(60) Provisional application No. 63/779,611, filed on Mar. 28, 2025.

(51) Int. Cl. H04N 19/137; H04N 19/172; H04N 19/176

(52) U.S. Cl. CPC H04N 19/137; H04N 19/172; H04N 19/176

(57) ABSTRACT

A method of decoding a bitstream to output one or more pictures for a video stream includes: receiving a bitstream; and decoding, using coded information of the bitstream, one or more pictures. The decoding includes: determining a first motion vector predictor (MVP) and a second motion vector predictor (MVP) for a bi-predictive block coded in an advanced motion vector prediction (AMVP) mode, in which the first MVP is obtained from a first reference picture, and the second MVP is obtained from a second reference picture; and applying at least one of a decoder-side motion vector refinement (DMVR) process or a bilateral matching (BM) process based on a bilateral matching cost to refine at least one of the first MVP or the second MVP.

### CROSS-REFERENCE TO RELATED APPLICATIONS

This application claims priority to U.S. Provisional Application No. 63/779,611, titled “ADAPTIVE MOTION VECTOR PREDICTOR WITH DECODER SIDE MOTION VECTOR REFINEMENT,” filed on Mar. 28, 2025, which is hereby incorporated by reference in its entirety.

### TECHNICAL FIELD

The present disclosure generally relates to video processing, and more particularly, to methods and apparatuses for adaptive motion vector predictor with decoder side motion vector refinement.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY

Embodiments of the present disclosure provide methods and apparatuses for adaptive motion vector predictor with decoder side motion vector refinement.

According to some embodiments, a method of decoding a bitstream to output one or more pictures for a video stream includes: receiving a bitstream; and decoding, using coded information of the bitstream, one or more pictures. The decoding includes: determining a first motion vector predictor (MVP) and a second motion vector predictor (MVP) for a bi-predictive block coded in an advanced motion vector prediction (AMVP) mode, in which the first MVP is obtained from a first reference picture, and the second MVP is obtained from a second reference picture; and applying at least one of a decoder-side motion vector refinement (DMVR) process or a bilateral matching (BM) process based on a bilateral matching cost to refine at least one of the first MVP or the second MVP.

According to some embodiments, a method of encoding a video sequence into a bitstream includes: receiving a video sequence; encoding one or more pictures of the video sequence, in which the encoding includes: encoding a bi-predictive block in an advanced motion vector prediction (AMVP) mode, in which the bi-predictive block is decodable by determining a first motion vector predictor (MVP) obtained from a first reference picture and a second motion vector predictor (MVP) obtained from a second reference picture for the bi-predictive block, and applying at least one of a decoder-side motion vector refinement (DMVR) process or a bilateral matching (BM) process to the bi-predictive block based on a bilateral matching cost to refine at least one of the first MVP or the second MVP; and generating a bitstream based on the encoding.

According to some embodiments, a method for storing a bitstream includes: receiving a video sequence including one or more pictures; generating a bitstream including coded information associated with the video sequence, by: encoding a bi-predictive block in an advanced motion vector prediction (AMVP) mode, in which the bi-predictive block is decodable by determining a first motion vector predictor (MVP) obtained from a first reference picture and a second motion vector predictor (MVP) obtained from a second reference picture for the bi-predictive block, and applying at least one of a decoder-side motion vector refinement (DMVR) process or a bilateral matching (BM) process to the bi-predictive block based on a bilateral matching cost to refine at least one of the first MVP or the second MVP; and storing the bitstream in a non-transitory computer readable storage medium.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an exemplary video sequence, according to some embodiments of the present disclosure.

FIG. 2 illustrates a schematic diagram of an exemplary encoder of a video coding system, according to some embodiments of the present disclosure.

FIG. 3 illustrates a block diagram of an exemplary decoder of a video coding system, according to some embodiments of the present disclosure.

FIG. 4 is a block diagram of an exemplary apparatus for encoding or decoding a video, according to some embodiments of the present disclosure.

FIG. 5 illustrates an example 3×3 square search pattern for the first pass in the MP-DMVR, according to some embodiments of the present disclosure.

FIG. 6 is a schematic diagram illustrating diamond regions in a search area, according to some embodiments of the present disclosure.

FIG. 7 is a schematic diagram illustrating an exemplary process of applying decoder-side motion vector refinement (DMVR) to motion vector predictor (MVP), according to some embodiments of the present disclosure.

FIG. 8A is a schematic diagram illustrating an exemplary process of applying bilateral matching (BM) to MVP with MVP from L0-prediction direction fixed, according to some embodiments of the present disclosure.

FIG. 8B is a schematic diagram illustrating an exemplary process of applying BM to MVP with MVP from L1-prediction direction fixed, according to some embodiments of the present disclosure.

FIG. 9A is a schematic diagram illustrating an exemplary process of applying BM to MVP, according to some embodiments of the present disclosure.

FIG. 9B is a schematic diagram illustrating an exemplary process of applying BM to MVP, according to some embodiments of the present disclosure.

FIG. 10 is a flowchart for an example method for encoding a video bitstream, according to some embodiments of the present disclosure.

FIG. 11 is a flowchart for an example method for decoding a video bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc. In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

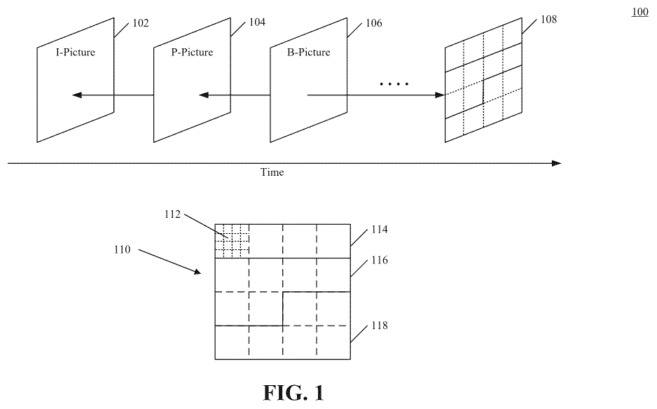

FIG. 1 illustrates structures of an exemplary video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may not be immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples, and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an exemplary structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit, and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vector (MV) difference, etc.) required for corresponding coding mode if inter coded, and quantized residual coefficients are sent.

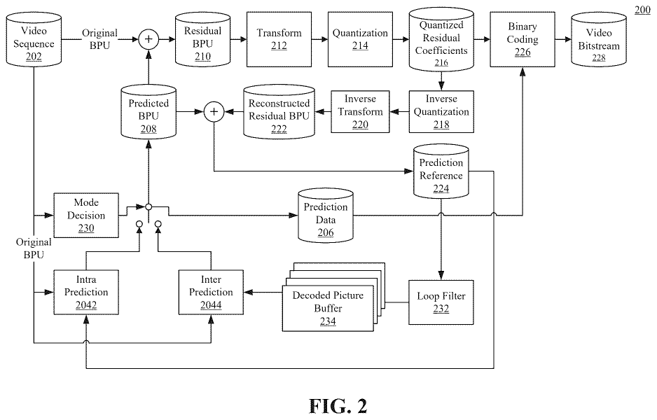

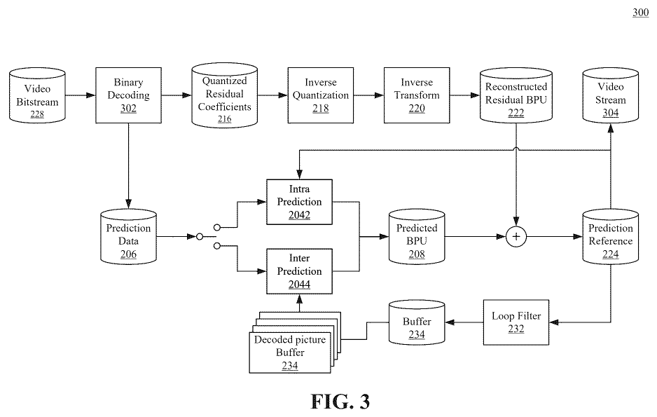

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

FIG. 2 illustrates a schematic diagram of an exemplary encoder 200 of a video coding system, (e.g., AVS3 or H.26x series), according to some embodiments of the present disclosure. The input video is processed block by block. As discussed above, in some coding standards (e.g., VVC), a coded tree unit (CTU) is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., slices 114-118 in FIG. 1) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensation,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2044, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” In other words, MV is the position difference between the reference block in the reference picture and the current block in the current picture. In inter prediction, the reference block is used as the predictor for the current block, so the reference block is also called predicted block. When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In some embodiments, under some specific inter coding modes, such as a skip mode or a direct mode, motion parameters (e.g., MV difference and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a video coding system (e.g., AVS3 or H.26x series), according to some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

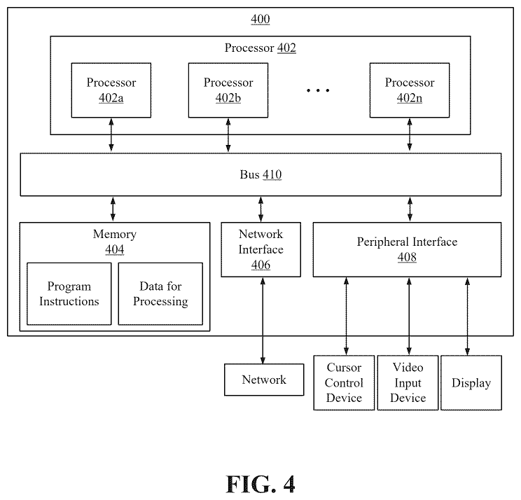

FIG. 4 is a block diagram of an exemplary apparatus 400 for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in FIG. 2 and FIG. 3) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in the present disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

In the inter prediction stage 2044 in FIG. 2 and FIG. 3, reference index is used to indicate which previously coded picture the reference block is from. The motion vector (MV), the position difference between the reference block in the reference picture and the current block in the current picture, is used to indicate the position of the reference block in the reference picture. For bi-prediction (e.g., picture 106 in FIG. 1), two reference blocks, one from a reference picture in reference picture List 0 (e.g., picture 104) and the other from a reference picture in reference picture List 1 (e.g., picture 108) are used to generate the combined predicted block. Accordingly, two reference indices, (e.g., List 0 reference index and List 1 reference index), and two motion vectors (e.g., List 0 motion vector and List 1 motion vector) are required for bi-prediction. The motion vector is determined by the encoder and signaled to the decoder. In some embodiments, to save the signaling cost, a motion vector difference (MVD) is signaled in the bitstream instead. For a decoder, a motion vector predictor (MVP) can be derived based on the spatial and temporal neighboring block motion information, and the MV can be obtained by adding the MVD parsed from the bitstream to the MVP.

As discussed above, the video encoding or decoding process can be achieved using different modes. In some normal inter coding modes, encoder 200 can signal MV(s), corresponding reference picture index for each reference picture list and reference picture list usage flag, or other information explicitly per each CU. On the other hand, when a CU is coded with a skip mode or a direct mode, the motion information, including reference index and motion vector, is not signaled in video bitstream 228 to decoder 300. Instead, the motion information can be derived at decoder 300 using the same rule as encoder 200 does. The skip mode and the direct mode share the same motion information derivation rule and thus have the same motion information. A difference between these two modes is that in the skip mode, the signaling of the prediction residuals is skipped by setting residuals to be zero. In the direct mode, prediction residuals are still signaled in the bitstream.

For example, when a CU is coded with a skip mode, the CU is associated with one PU and has no significant residual coefficients, no coded MV difference or reference picture index. In the skip mode, the signaling of the residual data can be skipped by setting residuals to zero. In the direct mode, the residual data is transmitted while the motion information and partitions are derived.

On the other hand, in inter modes, encoder 200 can choose any allowed values for motion vector and reference index as the motion vector difference and reference index are signaled to decoder 300. Compared with inter modes signaling the motion information, the bits dedicated on the motion information can thus be saved in the skip mode or the direct mode. However, encoder 200 and decoder 300 need to follow the same rule to derive the motion vector and reference index to perform inter prediction 2044. In some embodiments, the derivation of the motion information can be based on the spatial or temporal neighboring block. Accordingly, the skip mode and the direct mode are suitable for the case where the motion information of the current block is close to that of the spatial or temporal neighboring blocks of the current block.

For example, the skip mode or the direct mode may enable the motion information (e.g., reference index, MVs, etc.) to be inherited from a spatial or temporal (co-located) neighbor. A candidate list of motion candidates can be generated from these neighbors. In some embodiments, to derive the motion information used for inter prediction 2044 in skip mode or direct mode, encoder 200 may first derive the candidate list of motion candidates and select one of the motion candidates to perform inter prediction 2044. When signaling video bitstream 228, encoder 200 may signal an index of the selected candidate. At the decoder side, decoder 300 can obtain the index parsed from video bitstream 228, derive the same candidate list, and use the same motion candidate (including motion vector and reference picture index) to perform inter prediction 2044.

In some embodiments, there are different skip and direct modes, including normal skip and direct mode, ultimate motion vector expression mode, angular weighted prediction mode, enhanced temporal motion vector prediction mode and affine motion compensation skip/direct mode. The candidate list of motion candidates may include multiple candidates obtained based on different approaches. For example, for normal skip and direct model, a motion candidate list may have 12 candidates, including a temporal motion vector predictor (TMVP) candidate (i.e., a temporal candidate), one or more spatial motion vector predictor (SMVPs) candidates (i.e., spatial candidates), one or more motion vector angular predictor (MVAP) candidates (i.e., subblock based spatial candidates), and one or more history-based motion vector predictor (HMVP) candidates (i.e., history-based candidates). In some embodiments, the encoder or the decoder can first derive and add TMVP and SMVP candidates in the candidate list. After adding TMVP and SMVP candidates, the encoder or the decoder derives and add the MVAP candidates and HMVP candidates. In some embodiments, the number of MVAP candidates added in the candidate list may be varied according to the number of available direction(s) in the MVAP process. For example, the number of MVAP candidate(s) may be between 0 to a maximum number (e.g., 5). After adding MVAP candidate(s), one or more HMVP candidates can be added to the candidate list until the total number of the candidates reaches the target number and the largest number can also be signaled in the bitstream.

In some embodiments, the first candidate is the TMVP derived from the MV of collocated block in a pre-defined reference frame. The pre-defined reference frame is defined as the reference frame with reference index being 0 in the List1 for B frame or List0 for P frame. When the MV of the collocated block is unavailable, a MV predictor (MVP) derived based on the MV of spatial neighboring blocks is used as a block level TMVP.

Next, multi-pass decoder-side motion vector refinement (MP-DMVR) is described. In some embodiments, multi-pass decoder-side motion vector refinement can be used.

In ECM, to further improve the coding efficiency, a multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

Next, a first pass is described. In some embodiments, the first pass may be the block based bilateral matching MV refinement. In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initial MVs based on the minimum bilateral matching cost between the two reference blocks in the reference picture lists L0 and L1.

BM performs local search to derive integer sample precision intDeltaMV. The local search applies a 3×3 square search pattern to loop through the search range [−sHor, sHor] in horizontal direction and [−sVer, sVer] in vertical direction. The values of sHor and sVer are determined by the block dimension, and the maximum value of sHor and sVer is 8, or may be other values.

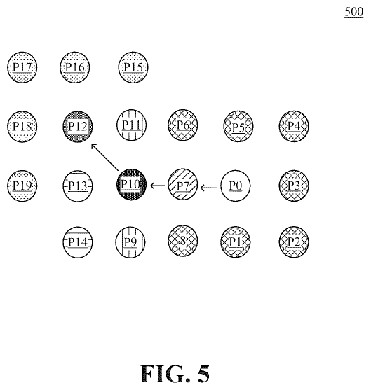

FIG. 5 illustrates an example 3×3 square search pattern 500 for the first pass in the MP-DMVR, according to some embodiments of the present disclosure. For example, as in FIG. 5, point P0 is the position to which the initial MV refers. So, the points P1-P8 surrounding the initial position are searched first and the cost of each position is calculated. If point P7 is with minimum cost, then point P7 is set as search center and points P9-P11 are searched. If cost of point P10 is smaller than the point P7, the search center goes to point P10 and points P12-P14 are searched. If point P12 has the minimum cost among points P6-14, point P12 is set as new search center. If points P10, P11, P13, and P15-P19 surrounding the point P12 are all larger than point P12, then point 12 is the best position and the search process stops.

The bilateral matching cost is calculated as: bilCost=mvDistanceCost+sadCost, in which sadCost is the SAD between 10 predictor and 11 predictor on each search point and mvDistanceCost is based on intDeltaMV (i.e., the distance between the search point and the initial position). When the block size cbW*cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continues to search for the minimum cost, until it reaches the end of the search range.

The existing fractional sample refinement is further applied to derive the final deltaMV. The refined MVs after the first pass is then derived based on the following equations:

$$MV 0 \_pass 1 = MV 0 + deltaMV$$

$$MV 1 \_pass 1 = MV 1 - deltaMV$$

Next, a second pass is described. In some embodiments, the second pass may be the subblock based bilateral matching MV refinement. In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV (sbIdx2). The full search has a search range [−sHor, sHor] in horizontal direction and [−sVer, sVer] in vertical direction. The values of sHor and sVer are determined by the block dimension, and the maximum value of sHor and sVer is 8 or may be other values.

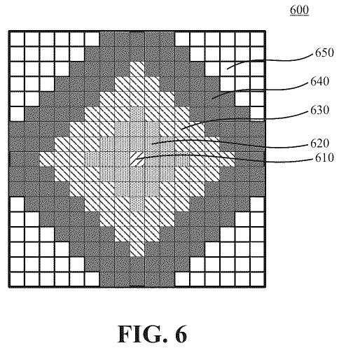

FIG. 6 illustrates an example of diamond regions 610-650 in the search area 600 for the second pass in the MP-DMVR, according to some embodiments of the present disclosure. The bilateral matching cost is calculated by applying a cost factor to the sum of absolute transformed differences (SATD) cost between two reference subblocks, as: bilCost=satdCost*costFactor. The search area (2*sHor+1)*(2*sVer+1) is divided up to 5 diamond shape search regions 610-650 shown on FIG. 6. Each search region 610-650 is assigned with a costFactor, which is determined by the distance (intDeltaMV) between each search point and the starting MV, and each diamond region 610-650 is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement can be further applied to derive the final deltaMV (sbIdx2). The refined MVs at second pass is then derived based on the following equations:

$$MV 0 \_pass 2 ( sbIdx 2 ) = MV 0 \_pass 1 + deltaMV ( sbIdx 2 )$$

$$MV 1 \_pass 2 ( sbIdx 2 ) = MV 1 \_pass 1 - deltaMV ( sbIdx 2 )$$

Next, a third pass is described. In some embodiments, the third pass may be the subblock based bi-directional optical flow MV refinement. In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3 (sbIdx3) and MV1_pass3 (sbIdx3)) at the third pass are derived based on the following equations:

$$MV 0 \_pass 3 ( sbIdx 3 ) = MV 0 \_pass 2 ( sbIdx 2 ) + bioMv$$

$$MV 1 \_pass 3 ( sbIdx 3 ) = MV 0 \_pass 2 ( sbIdx 2 ) - bioMv$$

Next, the fourth pass is described. In some embodiments, the fourth pass may be the adaptive subblock based bi-directional optical flow MV refinement. In the fourth pass, a refined MV is derived by applying BDOF to a 4×4, 8×8, or 16×16 grid subblock. In some embodiments, when a block is smaller than 1024 pixels, the 4×4 grid subblock is used. Otherwise, 8×8 grid subblock is used. The MV of each subblock is refined in the same way as that used in the third pass.

It is noted that, in the aforementioned embodiments, when wrap around motion compensation is enabled, the motion vectors shall be clipped with wrap around offset taken into consideration. It is noted that in ECM, the DMVR can be extended to non-equal POC (Picture Order Count) distance cases, and the mean removed equations are utilized to derive the BDOF MV refinement parameters (also known as high accuracy sample adjustment method), based on the following equations:

$$( Σ {G}_{x} {G}_{x} + {R}_{1} ) {v}_{x} + Σ {G}_{x} {G}_{y} {v}_{y} = Σ dI \cdot {G}_{x} ⇒$$

$$( Σ {G}_{x} {G}_{x} + {R}_{1} ) {v}_{x} + Σ {G}_{x} {G}_{y} {v}_{y} = Σ dI \cdot {G}_{x} - dM \cdot Σ {G}_{x}$$

$$Σ {G}_{x} {G}_{y} {v}_{x} + ( Σ {G}_{y} {G}_{y} + {R}_{1} ) {v}_{y} = Σ {dI}^{′} \cdot {G}_{y} ⇒$$

$$Σ {G}_{x} {G}_{y} {v}_{x} + ( Σ {G}_{y} {G}_{y} + {R}_{1} ) {v}_{y} = Σ dI \cdot {G}_{y} - dM \cdot Σ {G}_{y}$$

In some embodiments, adaptive decoder side motion vector refinement (DMVR) can be used. Adaptive decoder side motion vector refinement method is an extension of multi-pass DMVR which consists of the two new merge modes to refine MV only in one direction, either L0 or L1, of the bi-prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR. Thus, a new merge candidate list is constructed for adaptive decoder-side motion vector refinement. And the new merge mode for the new merge candidate list is called BM merge in ECM.

The merge candidates for the BM merge mode are derived from spatial neighboring coded blocks, TMVPs, non-adjacent blocks, history-based motion vector predictors (HMVPs), pair-wise candidate, similar as in the regular merge mode. The difference is that only those merge candidates meeting DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

In some embodiments, DMVR can be used for affine merge coded blocks. For example, DMVR can be applied to affine merge coded blocks and affine MMVD coded blocks when DMVR condition is satisfied. In some embodiments, it is also extended to adaptive BM merge mode.

In some embodiments, an affine motion field can be modelized based on the following equations (for a 6-parameters affine case):

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

where (mvₓ, mv_{y}) is the motion vector at location (x, y) and (mv₀ₓ, mv_{0y}) is the base MV representing the translation motion of the affine model. Parameters

$$\frac{{mv}_{1 x} - {mv}_{0 x}}{W} , \frac{{mv}_{2 x} - {mv}_{0 x}}{H} ,$$

$$\frac{{mv}_{1 y} - {mv}_{0 y}}{W} and \frac{{mv}_{2 y} - {mv}_{0 y}}{H}$$

represent the non-translation parameters (rotation, scaling).

Motion vectors (mv₀ₓ, mv_{0y}), (mv₁ₓ, mv_{1y}) and (mv₂ₓ, mv_{2y}) are called the control point motion vectors (CPMVs) of the considered affine coding unit. In the DMVR process applied to affine, the bilateral matching cost is calculated per subblock. Then, the subblock bilateral matching costs and refined subblock MVs are used to determine the overall best refined CPMVs for the affine block. In some embodiments, the CPMVs are refined according to the following steps.

In the first step, an integer-pel bilateral matching is performed for subblocks, and the subblock bilateral matching cost is accumulated to determine the best integer-pel MV offset.

In the second step, a half-pel bilateral matching search is performed, using the best integer MV offset as initial offset to output the best MV offset that minimizes the bilateral matching cost for the same set of the subblocks of the first step.

In the third step, a linear regression is performed using the refined subblock MVs from the first step as input, to output a set of control-point motion vectors.

In the fourth step, the bilateral matching cost of the output of the second and third steps are Compared to select the one with the smallest cost.

In addition, the non-translation parameters of affine model can be refined after the base MV are determined. Each of CPMVs is fixed as base MV in turn, and an offset is added to the non-translation parameter of affine model by minimizing the bilateral matching cost, and then the other two CPMVs can be calculated according to based MV and refined non-translation parameters.

For affine merge and affine MMVD modes, both CPMVs and non-translation parameters refinements are applied. When applying to affine MMVD mode, the MMVD offset is added to the affine DMVR refined affine merge base candidate if the base candidate meets the affine DMVR refinement condition. For adaptive BM merge mode, an affine merge list that only contains affine merge candidates that meet the affine DMVR conditions are constructed and then CPMVs refinement and non-translation parameters refinement are applied.

In some embodiments, advanced motion vector prediction (AMVP) and affine AMVP list construction in ECM can be used. In the ECM design, the AMVP list for a target reference picture is constructed by including the following four types of candidates in order: (1) Spatial MVP from spatial neighbor CUs, (2) Temporal MVP from collocated blocks, (3) Non-adjacent spatial candidates, and (4) History-based MVP from a FIFO table. In some embodiments, the TM motion vector refinement and reordering based on TM cost may be applied to the candidates in the AMVP list.

For a bi-predictive block, two AMVP lists, one for L0-prediction direction and the other for L1-prediction direction, are separately derived. Each AMVP list can be derived using the same process as the process used for a uni-predictive block. In some embodiments, the affine AMVP list is constructed in a similar way for constructing the AMVP list.

In the above-described refinement techniques, the following problems can be observed. Because two AMVP lists for bi-predictive blocks are separately derived, when deriving AMVP list for L0-prediction direction, the motion vector predictor (MVP) from the reference picture list L1 is not considered. Similarly, when deriving AMVP list for L1-prediction direction, the MVP from the reference picture list L0 is not considered. This may result in suboptimal MVP candidate. Moreover, the DMVR process used for bi-prediction merge-coded block is not applied to bi-prediction AMVP mode, and this also makes AMVP mode become less efficient than the merge mode.

The present disclosure provides solutions to one or more of the above-described problems. To address above issues, in some embodiments, DMVR/BM is applied to MVP.

In some embodiments of the present disclosure, it is proposed to apply DMVR or BM to MVPs for bi-predictive blocks coded in AMVP mode. Then, MVDs are added to the refined MVPs. The AMVP mode may include regular AMVP mode, Symmetric Motion Vector Difference (SMVD) mode, affine AMVP mode or AMVP-merge mode.

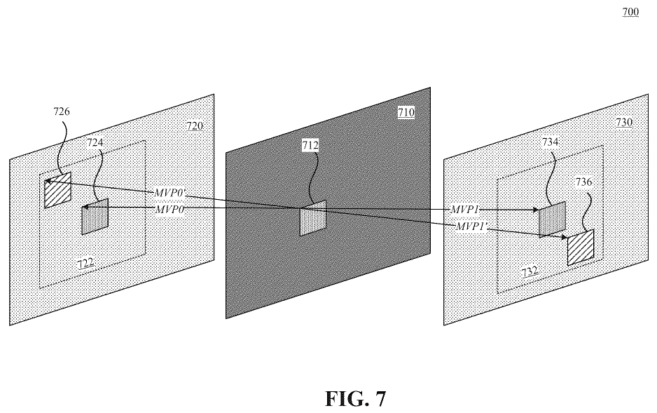

FIG. 7 is a schematic diagram illustrating an exemplary process 700 of applying decoder-side motion vector refinement (DMVR) to motion vector predictor (MVP), according to some embodiments of the present disclosure. In some embodiments, when two MVPs are determined for a block, the DMVR process is applied to refine the two MVPs, in which one of the two MVPs is from L0-prediction direction and the other one is from L1-prediction direction. The two MVPs may be derived using the same method as that of ECM design. The two MVPs may also be derived using different methods from that of ECM design. When applying the DMVR process to the two MVPs, only the block based bilateral matching MV refinement is used. For example, as shown in FIG. 7, the MVP0 and MVP1 are two MVPs determined for a bi-predictive block 712 in the current picture 710. The refined MVPs, MVP0′ and MVP1′, can be searched around the two initial MVPs MVP0 and MVP1 in the reference pictures 720 and 730, based on the searching ranges 722 and 732 respectively. The refined MVPs MVP0′ and MVP1′ are derived based on the minimum bilateral matching cost between the two reference blocks (e.g., reference blocks 724, 726, and 734, 736), in the reference picture lists L0 and L1.

In some embodiments, the BM (or the adaptive DMVR refinement) can be applied to refine two MVPs of a bi-predictive block. The two MVPs may be derived using the same method as that of ECM design. The two MVPs may also be derived using different methods from that of ECM design. When applying BM to two MVPs, one flag is signaled to indicate which one of the two MVPs is fixed.

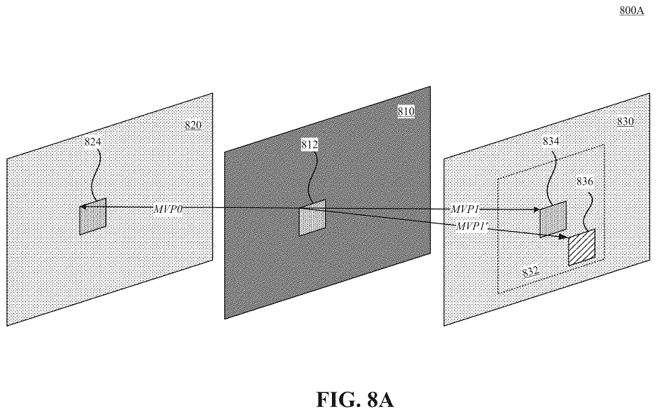

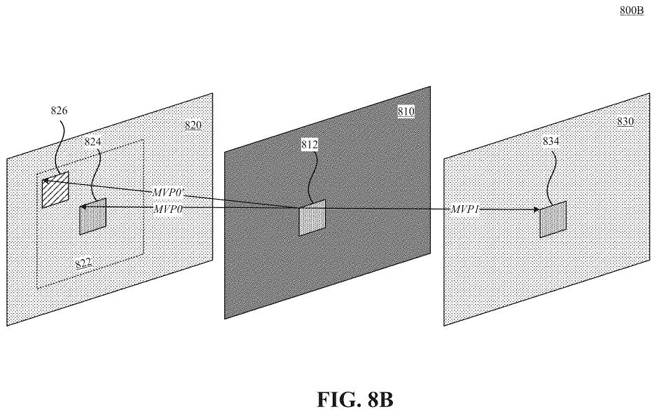

FIG. 8A is a schematic diagram illustrating an exemplary process 800A of applying bilateral matching (BM) to MVP with MVP from L0-prediction direction fixed, according to some embodiments of the present disclosure. FIG. 8B is a schematic diagram illustrating an exemplary process 800B of applying BM to MVP with MVP from L1-prediction direction fixed, according to some embodiments of the present disclosure.

FIG. 8A and FIG. 8B show examples when MVP0 and MVP1 are fixed, respectively. The flag can be signaled at CU-level, CTU-level, slice header, picture header, PPS or SPS. For example, as shown in FIGS. 8A-8B, the MVP0 and MVP1 are two MVPs determined for a bi-predictive block 812 in the current picture 810.

In the embodiments of FIG. 8A, when applying bilateral matching (BM) to MVP, MVP0 from L0-prediction direction is fixed, and the refined MVP, MVP1′, from L1-prediction direction can be searched around the initial MVP MVP1 in the reference picture 830, based on the searching ranges 832. The refined MVP MVP1′ can be derived based on the minimum bilateral matching cost between the reference blocks (e.g., reference blocks 834, 836), in the reference picture list L1.

In the embodiments of FIG. 8B, when applying bilateral matching (BM) to MVP, MVP1 from L1-prediction direction is fixed, and the refined MVP, MVP0′, from L0-prediction direction can be searched around the initial MVP MVP0 in the reference picture 820, based on the searching ranges 822. The refined MVP MVP0′ can be derived based on the minimum bilateral matching cost between the reference blocks (e.g., reference blocks 824, 826), in the reference picture list L0.

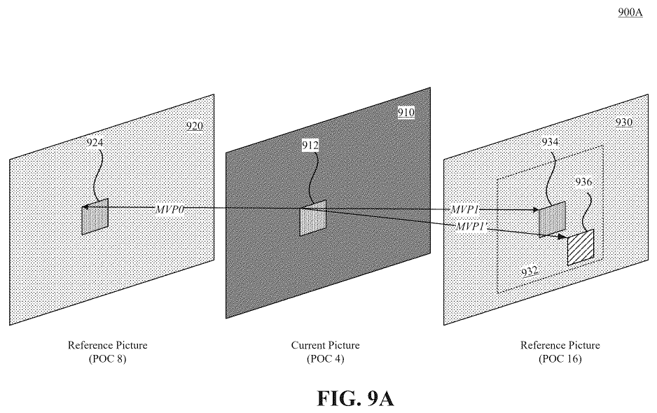

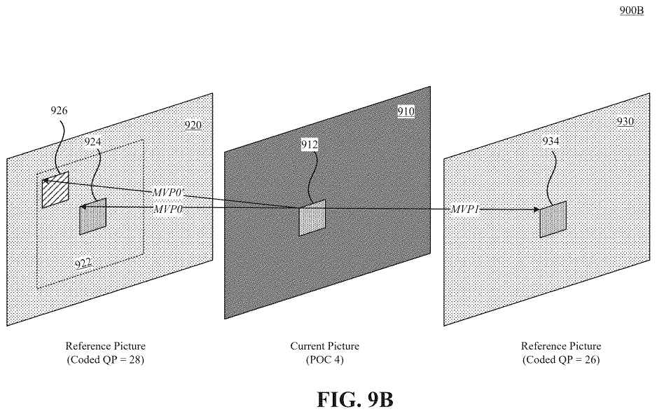

In some embodiments, the BM can be applied to refine two MVPs of a bi-predictive block. When applying BM to two MVPs, one of the two MVPs is fixed, and which one of the two MVPs fixed may be determined according to the information of reference pictures. FIG. 9A and FIG. 9B are schematic diagrams illustrating exemplary process 900A and 900B of applying BM to MVP, according to some embodiments of the present disclosure.

In one example, as shown in FIG. 9A, the POC value of the current picture 910 is 4, the POC value of the reference picture 920 from L0-prediction direction is 8, and the POC value of the reference picture 930 from L1-prediction direction is 16. In some embodiments, the fixed MVP can be the one obtained from a reference picture (e.g., reference picture 920) with a smaller POC distance between the current picture 910 and the reference picture 920 or 930.

In another example, as shown in FIG. 9B, the coded Quantization Parameter (QP) value of the reference picture 920 from L0-prediction direction is 28, and the coded QP value of the reference picture 930 from L1-prediction direction is 26. In some embodiments, the fixed MVP is the one obtained from a reference picture (e.g., reference picture 930) with a lower coded QP.

In some embodiments, it is proposed to apply DMVR to MVPs of a bi-predictive affine block, in which the MVPs are served as base MVs of the affine block during the DMVR process. In some embodiments, when performing the DMVR, only the translation motion is refined. That is, the non-translation parameters of affine model are not refined.

In some embodiments, it is proposed to apply DMVR to MVPs of a bi-predictive affine block. When performing the DMVR, the translation motion and the non-translation parameters of affine model are both refined. The DMVR process may be the same as that used for affine merge coded block.

In some embodiments, it is proposed to apply BM to MVPs of a bi-predictive affine block. When performing the BM, the translation motion is refined. The non-translation parameters of affine model may or may not refined. The BM process may be the same as that used for affine BM merge coded block.

It is noted that when applying DMVR or BM to the MVPs of a bi-predictive block or a bi-predictive affine block, it is not required that the POC distance between the current picture and the reference picture from L0-prediction direction is equal to the POC distance between current picture and the reference picture from L1-prediction direction.

It is also noted that when applying DMVR or BM to the MVPs of a bi-predictive block or a bi-predictive affine block, the two reference pictures can be both before or after the current picture in the display order. Alternatively, one of the two reference pictures may be before the current picture and the other of the two reference pictures may be after the current picture in the display order.

In some embodiments, DMVR/BM process can be applied to MV. For example, in some embodiments of the present disclosure, it is proposed to apply DMVR or BM process to the MVs of bi-predictive blocks coded in AMVP mode.

In some embodiments, the DMVR process used in merge mode can be applied to MVs of a bi-predictive block coded in regular AMVP mode or SMVD mode. The DMVR process may include one or more processes including block based bilateral matching MV refinement process, subblock based bilateral matching MV refinement and subblock based bi-directional optical flow MV refinement. In some embodiments, only the subblock based bi-directional optical flow MV refinement is applied to the MVs. In some other embodiments, both the block based bilateral matching MV refinement process and subblock based bilateral matching MV refinement process are applied to the MVs.

In some embodiments, the DMVR process used in affine merge mode can be applied to MVs of a bi-predictive block coded in affine AMVP mode. The DMVR process may include one or more processes including translation motion refinement or non-translation parameter refinement.

In some embodiments, the block based bilateral matching MV refinement process (e.g., 1^{st} pass of DMVR) can be applied to MVPs of a bi-predictive block. Then, the MVDs are added to the refined MVPs to obtain the MV of the bi-predictive block. The subblock based bilateral matching MV refinement (e.g., 2^{nd} pass of DMVR) and subblock based bi-directional optical flow MV refinement (e.g., 3^{rd} pass of DMVR) can be applied to the MVs.

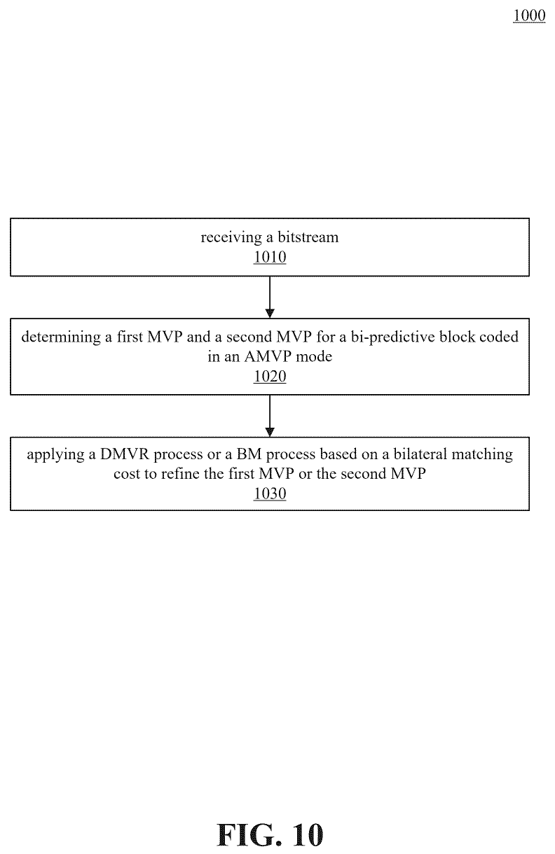

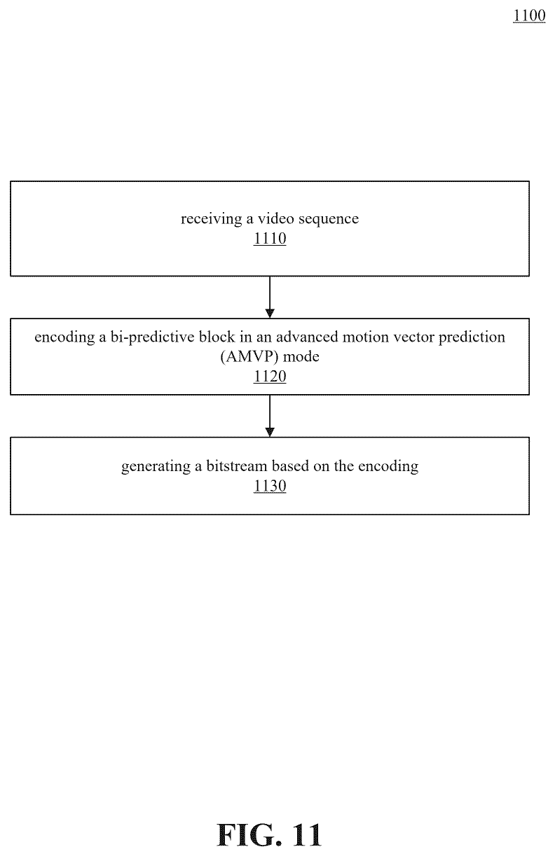

FIG. 10 is a flowchart for an example method 1000 for decoding a bitstream to output one or more pictures for a video stream, according to some embodiments of the present disclosure. In some embodiments, the method 1000 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 1000. As shown in FIG. 11, the method 1000 may include steps 1010-1030.

At step 1010, the decoder receives a bitstream (e.g., bitstream 228 in FIG. 3). Then, at steps 1020 and 1030, the decoder decodes, using coded information of the bitstream, one or more pictures. Specifically, at step 1020, the decoder determines a first MVP and a second MVP for a bi-predictive block coded in an AMVP mode. The first MVP is obtained from a first reference picture, and the second MVP is obtained from a second reference picture. At step 1030, the decoder applies at least one of a DMVR process or a BM process based on a bilateral matching cost to refine at least one of the first MVP or the second MVP and get a first refined MVP from the first reference picture or a second refined MVP from the second reference picture.

In some embodiments, at step 1030, the decoder refines both the first MVP and the second MVP during the DMVR process or the BM process. In some other embodiments, at step 1030, the decoder refines one of the first MVP or the second MVP, and keeping the other one of the first MVP or the second MVP fixed during the DMVR process or the BM process. The decoder may decode a flag for indicating which one of the first MVP or the second MVP is fixed.

The fixed MVP can be determined based on the POC distance or the coded QP of the reference picture. For example, in some embodiments, when the first reference picture has a smaller picture order count (POC) distance than the second reference picture, the first MVP is fixed. When the second reference picture has a smaller picture order count (POC) distance than the first reference picture, the second MVP is fixed. In some other embodiments, when the first reference picture has a lower coded QP than the second reference picture, the first MVP is fixed. When the second reference picture has a lower coded QP than the first reference picture, the second MVP is fixed.

In some embodiments, when the bi-predictive block is a bi-predictive affine block, the decoder may refine a translation motion of an affine model during the DMVR process without refining non-translation parameters of the affine model. In some other embodiments, the decoder may refine both the translation motion and non-translation parameters of the affine model during the DMVR process. In yet some other embodiments, when the bi-predictive block is a bi-predictive affine block, the decoder may refine the translation motion of the affine model during the BM process, with or without refining non-translation parameters of the affine model.

In some embodiments, the decoder may further apply the DMVR process or the BM process to refine one or more motion vectors of the bi-predictive block coded in the AMVP mode. For example, the DMVR process may include at least one of a block-based bilateral matching MV refinement process, a subblock-based bilateral matching MV refinement, or a subblock-based bi-directional optical flow MV refinement, as described in the above embodiments.

Detailed operations of the DMVR process or the BM process are discussed above in detail in the embodiments of the present disclosure, and thus are not repeated herein for the sake of brevity.

FIG. 11 is a flowchart for an example method 1100 of encoding a video sequence into a bitstream, according to some embodiments of the present disclosure. The method 1100 can be performed by an encoder (e.g., encoder 200 in FIG. 2) to encode a video bitstream. For example, the encoder can be implemented as one or more software or hardware components of an apparatus (e.g., apparatus 400 in FIG. 4) for encoding the bitstream (e.g., video bitstream 228 in FIG. 2) for reconstructing a video frame or a video sequence. For example, a processor (e.g., processor 402 in FIG. 4) can perform the method 1100. As shown in FIG. 11, the method 1100 includes the following steps 1110-1130.

At step 1110, the encoder receives a video sequence (e.g., video sequence 202 in FIG. 2). At step 1120, the encoder encodes one or more pictures of the video sequence. The encoding operation performed in step 1120 includes encoding a bi-predictive block in an advanced motion vector prediction (AMVP) mode. The bi-predictive block is decodable by determining a first MVP obtained from a first reference picture and a second MVP obtained from a second reference picture for the bi-predictive block, and applying at least one of a DMVR process or a BM process to the bi-predictive block based on a bilateral matching cost to refine at least one of the first MVP or the second MVP. At step 1130, the encoder generates a bitstream (e.g., video bitstream 228 in FIG. 2) based on the encoding operation performed in step 1120. In some embodiments, the encoder further transmits the generated bitstream through a public network or a private network.

Similar to the method 1000 of decoding a bitstream in FIG. 10 discussed above, in some embodiments, both the first MVP and the second MVP can be refined during the DMVR process or the BM process. In some other embodiments, one of the first MVP or the second MVP is refined, and the other one of the first MVP or the second MVP is fixed during the DMVR process or the BM process, and the encoder may encode a flag for indicating which one of the first MVP or the second MVP is fixed.

For example, the fixed MVP can be determined based on the POC distance or the coded QP of the reference picture. Detailed operations of determining the fixed MVP based on the POC distance or the coded QP of the reference picture are discussed above in detail in the embodiments of the present disclosure, and thus are not repeated herein for the sake of brevity.

Similar to the method 1000 of decoding a bitstream in FIG. 10 discussed above, in some embodiments, when the bi-predictive block is a bi-predictive affine block, a translation motion of an affine model can be refined, while non-translation parameters of the affine model are unrefined during the DMVR process. In some other embodiments, both the translation motion and non-translation parameters of an affine model can be refined during the DMVR process. In yet some other embodiments, a translation motion of an affine model can be refined during the BM process.

The embodiments described in the present disclosure can be freely combined.

In some embodiments, a non-transitory computer-readable storage medium storing a bitstream is also provided. The bitstream can be decoded and encoded according to the disclosed methods 1000 and 1100 in FIG. 10 and FIG. 11 for the adaptive motion vector predictor with decoder side motion vector refinement.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

In some embodiments, a method for storing a bitstream is also provided. The method includes receiving a video sequence including one or more pictures, generating a bitstream including coded information associated with the video sequence, and storing the bitstream in a non-transitory computer-readable medium. The operations of generating the bitstream includes steps that are the same or similar to those of method 1100 in FIG. 11 discussed above, and thus are not repeated herein for the sake of brevity.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A method of decoding a bitstream to output one or more pictures for a video stream, the method comprising:
receiving a bitstream; and
decoding, using coded information of the bitstream, one or more pictures, wherein the decoding comprises:
   determining a first motion vector predictor (MVP) and a second motion vector predictor (MVP) for a bi-predictive block coded in an advanced motion vector prediction (AMVP) mode, wherein the first MVP is obtained from a first reference picture, and the second MVP is obtained from a second reference picture; and
   applying at least one of a decoder-side motion vector refinement (DMVR) process or a bilateral matching (BM) process based on a bilateral matching cost to refine at least one of the first MVP or the second MVP.

2. The method according to clause 1, further comprising:
refining both the first MVP and the second MVP during the DMVR process or the BM process.

3. The method according to clause 1 or 2, further comprising:
refining one of the first MVP or the second MVP, and keeping the other one of the first MVP or the second MVP fixed during the DMVR process or the BM process.

4. The method according to clause 3, further comprising:
decoding a flag for indicating which one of the first MVP or the second MVP is fixed.

5. The method according to clause 3 or 4, wherein when the first reference picture has a smaller picture order count (POC) distance than the second reference picture, the first MVP is fixed, or when the second reference picture has a lower coded QP than the first reference picture, the second MVP is fixed.

6. The method according to any of clauses 3-5, wherein when the first reference picture has a lower coded quantization parameter (QP) than the second reference picture, the first MVP is fixed, or when the second reference picture has a lower coded QP than the first reference picture, the second MVP is fixed.

7. The method according to any of clauses 1-6, further comprising:
refining a translation motion of an affine model during the DMVR process without refining non-translation parameters of the affine model, wherein the bi-predictive block is a bi-predictive affine block.

8. The method according to any of clauses 1-7, further comprising:
refining both a translation motion and non-translation parameters of an affine model during the DMVR process, wherein the bi-predictive block is a bi-predictive affine block.

9. The method according to any of clauses 1-8, further comprising:
refining a translation motion of an affine model during the BM process, with or without refining non-translation parameters of the affine model, wherein the bi-predictive block is a bi-predictive affine block.

10. The method according to any of clauses 1-9, further comprising:
applying the DMVR process or the BM process to refine one or more motion vectors of the bi-predictive block coded in the AMVP mode, wherein the DMVR process comprises at least one of a block-based bilateral matching MV refinement process, a subblock-based bilateral matching MV refinement, or a subblock-based bi-directional optical flow MV refinement.

11. A method of encoding a video sequence into a bitstream, the method comprising:
receiving a video sequence;
encoding one or more pictures of the video sequence, wherein the encoding comprises:
   encoding a bi-predictive block in an advanced motion vector prediction (AMVP) mode,
   wherein the bi-predictive block is decodable by determining a first motion vector predictor (MVP) obtained from a first reference picture and a second motion vector predictor (MVP) obtained from a second reference picture for the bi-predictive block, and applying at least one of a decoder-side motion vector refinement (DMVR) process or a bilateral matching (BM) process to the bi-predictive block based on a bilateral matching cost to refine at least one of the first MVP or the second MVP; and generating a bitstream based on the encoding.

12. The method according to clause 11, wherein both the first MVP and the second MVP are refined during the DMVR process or the BM process.

13. The method according to clause 11 or 12, wherein one of the first MVP or the second MVP is refined, and the other one of the first MVP or the second MVP is fixed during the DMVR process or the BM process.

14. The method according to clause 13, further comprising:
encoding a flag for indicating which one of the first MVP or the second MVP is fixed.

15. The method according to clause 13 or 14, wherein when the first reference picture has a smaller picture order count (POC) distance than the second reference picture, the first MVP is fixed, or when the second reference picture has a lower coded QP than the first reference picture, the second MVP is fixed.

16. The method according to any of clauses 13-15, wherein when the first reference picture has a lower coded quantization parameter (QP) than the second reference picture, the first MVP is fixed, or when the second reference picture has a lower coded QP than the first reference picture, the second MVP is fixed.

17. The method according to any of clauses 11-16, wherein the bi-predictive block is a bi-predictive affine block, and a translation motion of an affine model is refined, and non-translation parameters of the affine model are unrefined during the DMVR process.

18. The method according to any of clauses 11-17, wherein the bi-predictive block is a bi-predictive affine block, and both a translation motion and non-translation parameters of an affine model are refined during the DMVR process.

19. The method according to any of clauses 11-18, further comprising:
transmitting the bitstream through a public network or a private network.

20. A method for storing a bitstream, comprising:
receiving a video sequence including one or more pictures;
generating a bitstream comprising coded information associated with the video sequence, by:
   encoding a bi-predictive block in an advanced motion vector prediction (AMVP) mode,
   wherein the bi-predictive block is decodable by determining a first motion vector predictor (MVP) obtained from a first reference picture and a second motion vector predictor (MVP) obtained from a second reference picture for the bi-predictive block, and applying at least one of a decoder-side motion vector refinement (DMVR) process or a bilateral matching (BM) process to the bi-predictive block based on a bilateral matching cost to refine at least one of the first MVP or the second MVP; and storing the bitstream in a non-transitory computer readable storage medium.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of decoding a bitstream to output one or more pictures for a video stream, the method comprising:
receiving a bitstream; and
decoding, using coded information of the bitstream, one or more pictures, wherein the decoding comprises:
determining a first motion vector predictor (MVP) and a second motion vector predictor (MVP) for a bi-predictive block coded in an advanced motion vector prediction (AMVP) mode, wherein the first MVP is obtained from a first reference picture, and the second MVP is obtained from a second reference picture; and
applying at least one of a decoder-side motion vector refinement (DMVR) process or a bilateral matching (BM) process based on a bilateral matching cost to refine at least one of the first MVP or the second MVP.

2. The method according to claim 1, further comprising:
refining both the first MVP and the second MVP during the DMVR process or the BM process.

3. The method according to claim 1, further comprising:
refining one of the first MVP or the second MVP, and keeping the other one of the first MVP or the second MVP fixed during the DMVR process or the BM process.

4. The method according to claim 3, further comprising:
decoding a flag for indicating which one of the first MVP or the second MVP is fixed.

5. The method according to claim 3, wherein when the first reference picture has a smaller picture order count (POC) distance than the second reference picture, the first MVP is fixed, or when the second reference picture has a lower coded QP than the first reference picture, the second MVP is fixed.

6. The method according to claim 3, wherein when the first reference picture has a lower coded quantization parameter (QP) than the second reference picture, the first MVP is fixed, or when the second reference picture has a lower coded QP than the first reference picture, the second MVP is fixed.

7. The method according to claim 1, further comprising:
refining a translation motion of an affine model during the DMVR process without refining non-translation parameters of the affine model, wherein the bi-predictive block is a bi-predictive affine block.

8. The method according to claim 1, further comprising:
refining both a translation motion and non-translation parameters of an affine model during the DMVR process, wherein the bi-predictive block is a bi-predictive affine block.

9. The method according to claim 1, further comprising:
refining a translation motion of an affine model during the BM process, with or without refining non-translation parameters of the affine model, wherein the bi-predictive block is a bi-predictive affine block.

10. The method according to claim 1, further comprising:
applying the DMVR process or the BM process to refine one or more motion vectors of the bi-predictive block coded in the AMVP mode, wherein the DMVR process comprises at least one of a block-based bilateral matching MV refinement process, a subblock-based bilateral matching MV refinement, or a subblock-based bi-directional optical flow MV refinement.

11. A method of encoding a video sequence into a bitstream, the method comprising:
receiving a video sequence;
encoding one or more pictures of the video sequence, wherein the encoding comprises:
encoding a bi-predictive block in an advanced motion vector prediction (AMVP) mode,
wherein the bi-predictive block is decodable by determining a first motion vector predictor (MVP) obtained from a first reference picture and a second motion vector predictor (MVP) obtained from a second reference picture for the bi-predictive block, and applying at least one of a decoder-side motion vector refinement (DMVR) process or a bilateral matching (BM) process to the bi-predictive block based on a bilateral matching cost to refine at least one of the first MVP or the second MVP; and
generating a bitstream based on the encoding.

12. The method according to claim 11, wherein both the first MVP and the second MVP are refined during the DMVR process or the BM process.

13. The method according to claim 11, wherein one of the first MVP or the second MVP is refined, and the other one of the first MVP or the second MVP is fixed during the DMVR process or the BM process.

14. The method according to claim 13, further comprising:
encoding a flag for indicating which one of the first MVP or the second MVP is fixed.

15. The method according to claim 13, wherein when the first reference picture has a smaller picture order count (POC) distance than the second reference picture, the first MVP is fixed, or when the second reference picture has a lower coded QP than the first reference picture, the second MVP is fixed.

16. The method according to claim 13, wherein when the first reference picture has a lower coded quantization parameter (QP) than the second reference picture, the first MVP is fixed, or when the second reference picture has a lower coded QP than the first reference picture, the second MVP is fixed.

17. The method according to claim 11, wherein the bi-predictive block is a bi-predictive affine block, and a translation motion of an affine model is refined, and non-translation parameters of the affine model are unrefined during the DMVR process.

18. The method according to claim 11, wherein the bi-predictive block is a bi-predictive affine block, and both a translation motion and non-translation parameters of an affine model are refined during the DMVR process.

19. The method according to claim 11, further comprising:
transmitting the bitstream through a public network or a private network.

20. A method for storing a bitstream, comprising:
receiving a video sequence including one or more pictures;
generating a bitstream comprising coded information associated with the video sequence, by:
encoding a bi-predictive block in an advanced motion vector prediction (AMVP) mode,
wherein the bi-predictive block is decodable by determining a first motion vector predictor (MVP) obtained from a first reference picture and a second motion vector predictor (MVP) obtained from a second reference picture for the bi-predictive block, and applying at least one of a decoder-side motion vector refinement (DMVR) process or a bilateral matching (BM) process to the bi-predictive block based on a bilateral matching cost to refine at least one of the first MVP or the second MVP; and
storing the bitstream in a non-transitory computer readable storage medium.
